(19) United States
(12) Patent Application Publication
(10) Pub. No.: US 2007/0097107 A1
(43) Pub. Date: May 3, 2007

(54) Liquid crystal display apparatus and liquid crystal display panel drive method capable of controlling gamma value

(76) Inventor: Yasutake Furukoshi, Kawasaki-shi (JP)

Correspondence Address: HARNESS, DICKEY & PIERCE, P.L.C., P.O. BOX 8910, RESTON, VA, 20195, US

(21) Appl. No.: 11/438,253

(22) Filed: May 23, 2006

(30) Foreign Application Priority Data
May 25, 2005 (JP) 2005-152899

(51) Int. Cl. G09G 5/00

(52) U.S. Cl. 345/204

(57) ABSTRACT

A liquid crystal display apparatus includes a liquid crystal panel, a data driver configured to drive the liquid crystal panel, and a control circuit configured to control the data driver in response to display data and a control signal supplied from an exterior, wherein the control circuit is configured to change a relationship between tones of the display data and voltages used by the data driver to drive the liquid crystal panel, such that the relationship is responsive to one of a horizontal cycle and a vertical cycle specified by the control signal.

### BACKGROUND OF THE INVENTION

1. Field of the Invention

The present invention generally relates to liquid crystal display apparatuses and liquid crystal display panel drive methods, and particularly relates to a liquid crystal display apparatus and liquid crystal display panel drive method provided with the function to control a gamma value.

2. Description of the Related Art

In various image-related apparatuses, the input/output characteristics of image tone is generally represented by a gamma (γ) value. In the case of a CRT, for example, the brightness of an image displayed on screen is typically proportional to the input signal voltage to the power of 2.2, which is referred to as having a gamma value of 2.2.

When the gamma value is not 1 as in this case, the brightness of a displayed image is not proportional to an image tone value even if the input signal voltage is proportional to the image tone. If the gamma value is larger than 1, a change in the brightness in response to a change in the input signal voltage is gentle as long as the input signal voltage is relatively small. As the input signal voltage increases, however, a change in the brightness in response to a change in the input signal voltage rapidly increases. Conversely, if the gamma value is smaller than 1, a change in the brightness in response to a change in the input signal voltage is steep when the input signal voltage is relatively small. As the input signal voltage increases, however, a change in the brightness in response to a change in the input signal voltage decreases. Namely, black areas in the output image saturate if γ>1, and white areas in the output image saturate if γ<1.

Image-related apparatuses such as cameras, scanners, and display apparatuses each have their own gamma values. In order to reproduce an image exactly as it should be by use of an image display apparatus after the image is captured by a camera, scanner, or the like, there is a need to set the gamma value to 1 with respect to the system as a whole from the inputting of the image to the final outputting of the image. If the gamma value of the scanner is 0.5 and the gamma value of the image display apparatus is 2.0, for example, a tone I of an original image will be reproduced on the image display apparatus exactly as it should be since the scanner output is I^{0.5} and the image display apparatus output is I^{(0.5)(2.0)}=I. If the image display apparatus is a CRT having a gamma value of 2.2 in this example, the image on the CRT screen will be an exact reproduction of an original image after the signal voltage input into the CRT is corrected by a gamma value of 2.0/2.2. In this manner, the input/output characteristics (gamma characteristics) may be corrected to achieve an optimum gamma value at an image output apparatus. Such correction is referred to as “gamma correction”.

In a liquid crystal display apparatus, pixels each including a transistor are arranged in matrix form, with gate bus lines extending in the horizontal direction being connected to the gates of the pixel transistors, and data bus lines extending in the vertical direction being coupled to the pixel electrodes of the pixels via the transistors. Each pixel electrode is positioned to face a common electrode (opposite electrode) across a liquid crystal layer, thereby forming a condenser corresponding to each pixel. When data is to be displayed on a liquid crystal panel, the gate driver drives the gate bus lines one after another so as to make the transistors conductive for one line, and the date driver writes data for one horizontal line to the pixels simultaneously via the conductive transistors.

In order to display a desired image by writing display data at proper timing to the liquid crystal panel having the configuration as described above, a timing controller is provided in the liquid crystal display apparatus. This timing controller receives a clock signal, display data, and a display enable signal indicative of the timing of the display position from an apparatus on the host side (television tuner, computer, or the like). The timing controller counts the clock pulses of the clock signal starting from a rise of the display enable signal so as to determine timing in the horizontal position, thereby generating various control signals. The timing controller also counts the number of display enable signals so as to determine timing in the vertical position, thereby generating various control signals. The timing controller further detects the portion of the display enable signal at which the LOW period continues for more than a predetermined number of clock pulses, thereby detecting the position of the start of each frame.

Such a liquid crystal display apparatus is configured such that the refresh rate (vertical scan cycle) of a displayed image can be selected from a plurality of different refresh rates. If the refresh rate is 60 Hz, the image is drawn on display screen 60 times in one second. In general, human visual perception may detect flickers if the refresh rate is less than 60 Hz, so that the refresh rate is preferably set higher than 60 Hz. In the case of liquid crystal display apparatuses, the data retention characteristics of display cells (pixel capacitors) are generally designed and manufactured such that 60 Hz becomes an optimum refresh rate in terms of flicker perception and power consumption. In order to satisfy user needs, however, higher refresh rates such as 70 Hz and 80 Hz are available as optional settings.

FIG. 1 is a drawing showing the relationship between the input tone and output luminance of a liquid crystal display apparatus. In FIG. 1, the horizontal axis represents the input tone, and the vertical axis represents the output luminance. The input/output characteristics (tone/luminance characteristics) shown here correspond to a gamma value as previously described.

FIG. 1 illustrates input/output characteristics for different refresh rates (18.5 Hz, 36.9 Hz, 60 Hz, 75 Hz, and 85 Hz). As illustrated, the input/output characteristics of a liquid crystal display apparatus vary depending on the refresh rate.

Even if the liquid crystal display apparatus is configured to achieve an optimum gamma value for a refresh rate of 60 Hz that is a standard setting, for example, the gamma value will be changed as the refresh rate is changed. Accordingly, the optimum gamma value (input/output characteristics) is not achieved after the refresh rate is changed to a different setting.

Accordingly, there is a need for a liquid crystal display apparatus that can maintain an optimum gamma value even when the refresh rate is changed.

### SUMMARY OF THE INVENTION

It is a general object of the present invention to provide a liquid crystal display apparatus and liquid crystal display panel drive method that substantially obviate one or more problems caused by the limitations and disadvantages of the related art.

It is another and more specific object of the present invention to provide a liquid crystal display apparatus that can maintain an optimum gamma value even when the refresh rate is changed.

According to the present invention, a liquid crystal display apparatus includes a liquid crystal panel, a data driver configured to drive the liquid crystal panel, and a control circuit configured to control the data driver in response to display data and a control signal supplied from an exterior, wherein the control circuit is configured to change a relationship between tones of the display data and voltages used by the data driver to drive the liquid crystal panel, such that the relationship is responsive to one of a horizontal cycle and a vertical cycle specified by the control signal.

According to the present invention, a method of driving a liquid crystal display panel includes receiving a display data signal and control signal, controlling a data driver for driving a liquid crystal panel based on the display data signal and the control signal, detecting one of a horizontal cycle and a vertical cycle specified by the control signal, and changing a relationship between tones of the display data and voltages used by the data driver to drive the liquid crystal panel, such that the relationship is responsive to the detected cycle.

According to at least one embodiment of the present invention, the relationship between the tones of the display data and the voltages used by the data driver to drive the liquid crystal panel is changed in response to one of the horizontal cycle and the vertical cycle specified by the control signal, so that the optimum gamma value can be maintained even when the refresh rate is changed.

### BRIEF DESCRIPTION OF THE DRAWINGS

FIG. 1 is a drawing showing the relationship between the input tone and output luminance of a liquid crystal display apparatus;

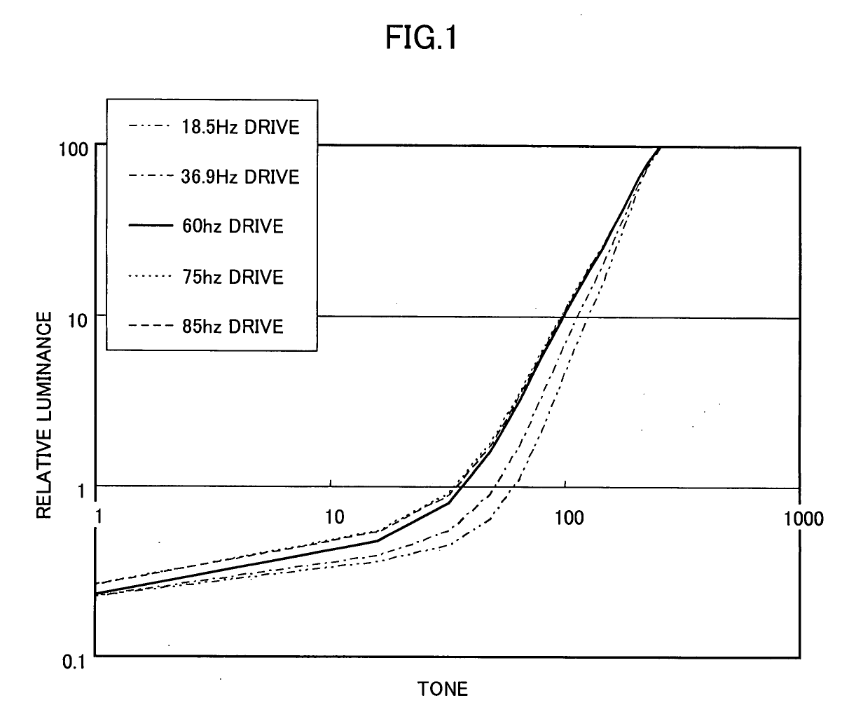

FIG. 2 is a drawing showing the configuration of a liquid crystal display apparatus;

FIG. 3 is a drawing showing the configuration of a timing-controller-&-power-supply circuit;

FIG. 4 is a drawing showing an example of the configuration of a data driver;

FIG. 5 is a drawing showing another example of the configuration of the timing-controller-&-power-supply circuit;

FIG. 6 is a drawing showing an example of the circuit configuration of a horizontal/vertical-cycle monitoring circuit; and

FIG. 7 is a timing chart showing the operation of the circuit of FIG. 6.

### DESCRIPTION OF THE PREFERRED EMBODIMENTS

In the following, embodiments of the present invention will be described with reference to the accompanying drawings.

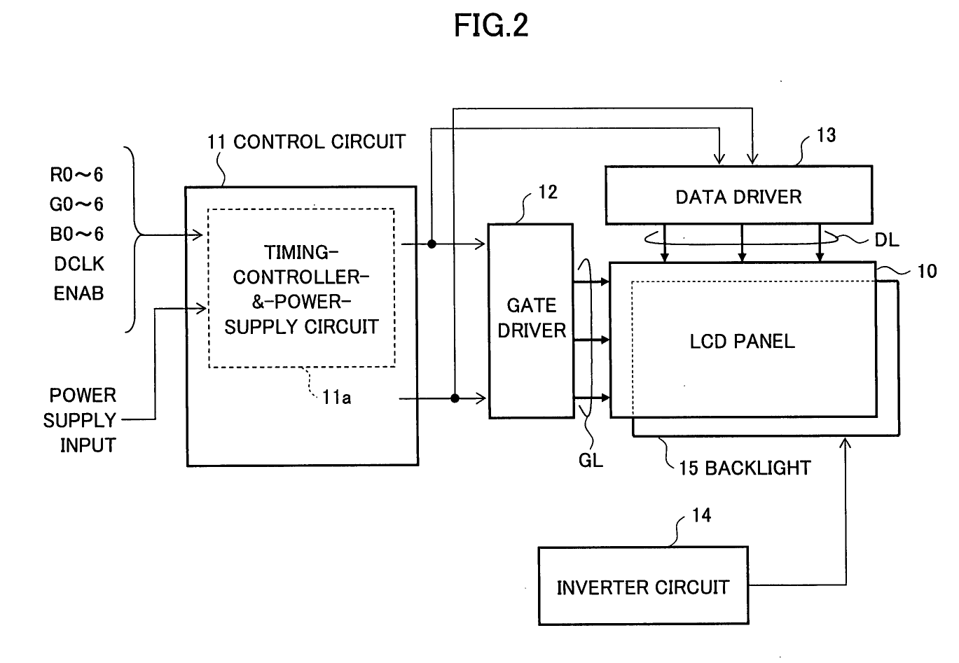

FIG. 2 is a drawing showing the configuration of a liquid crystal display apparatus according to the present invention.

The liquid crystal display apparatus of FIG. 2 includes an LCD panel 10, a control circuit 11, a gate driver 12, a data driver 13, an inverter circuit 14, and a backlight 15. The LCD panel 10 has pixels each including a transistor arranged in matrix form. Gate bus lines GL extending in the horizontal direction from the gate driver 12 are connected to the gates of the transistors of the pixels, and data bus lines DL extending in the vertical direction from the data driver 13 serve to write pixel data to the pixel electrodes via the transistors.

A timing-controller-&-power-supply circuit 11a of the control circuit 11 receives a display data signal and various control signals (timing signals) from a host apparatus via an interface. The display data signal and various control signals (timing signals) include a clock signal DCLK, display data RGB0-6, and a display enable signal ENAB indicative of the timing of display position. The timing-controller-&-power-supply circuit 11a counts the clock pulses of the clock signal starting from a rise of the display enable signal ENAB so as to determine timing in the horizontal position, thereby generating various control signals for driving the drivers. The timing-controller-&-power-supply circuit 11a also counts the number of display enable signals ENAB so as to determine timing in the vertical position, thereby generating various control signals for driving the drivers. The timing-controller-&-power-supply circuit 11a further detects the portion of the display enable signal ENAB at which the LOW period continues for more than a predetermined number of clock pulses, thereby making it possible to detect the position of the start of each frame.

The control signals supplied from the timing-controller-&-power-supply circuit 11a to the gate driver 12 include a gate clock signal and a start pulse signal. The gate clock signal is a synchronizing signal for shifting a driven gate bus line one by one in synchronization with a rise of the signal. To be specific, the transistors for one horizontal line having their gates switched on are shifted on a line-by-line basis in the vertical direction in synchronization with a rise in the gate clock signal. The start pulse signal is a synchronizing signal for specifying the timing at which the first gate bus line is turned on, and corresponds to the start timing of a frame.

The control signals supplied from the timing-controller-&-power-supply circuit 11a to the data driver 13 include a dot clock signal, a data start signal, a latch pulse, and a polarity signal. The dot clock signal has clock pulses used to load the display data to a register in synchronization with its rising edges. The data start signal serves to indicate the start position of the display data that is to be displayed by a corresponding data driver 13. Using the timing of the data start signal as a start point, the display data corresponding to individual pixels are loaded to the register one by one in response to the dot clock signal. The latch pulse serves to cause an internal latch to latch the display data successively loaded in the register. The latched display data is transferred to a DA converter, which converts the display data into analog gray-scale signals, which are then output to the LCD panel 10 as data bus line drive signals. The polarity signal is input into the DA converter to indicate the output polarity of each data bus line. Since the output polarity of each data bus line needs to be temporally reversed in order to prevent the degradation of liquid crystal characteristics, the polarity signal is used to select the output polarity of each data bus line relative to the common potential.

The inverter circuit 14 generates a high voltage for lighting a cold cathode tube based on the direct power supply voltage for provision to the backlight 15. The backlight 15 shines light on the LCD panel 10 from its back side.

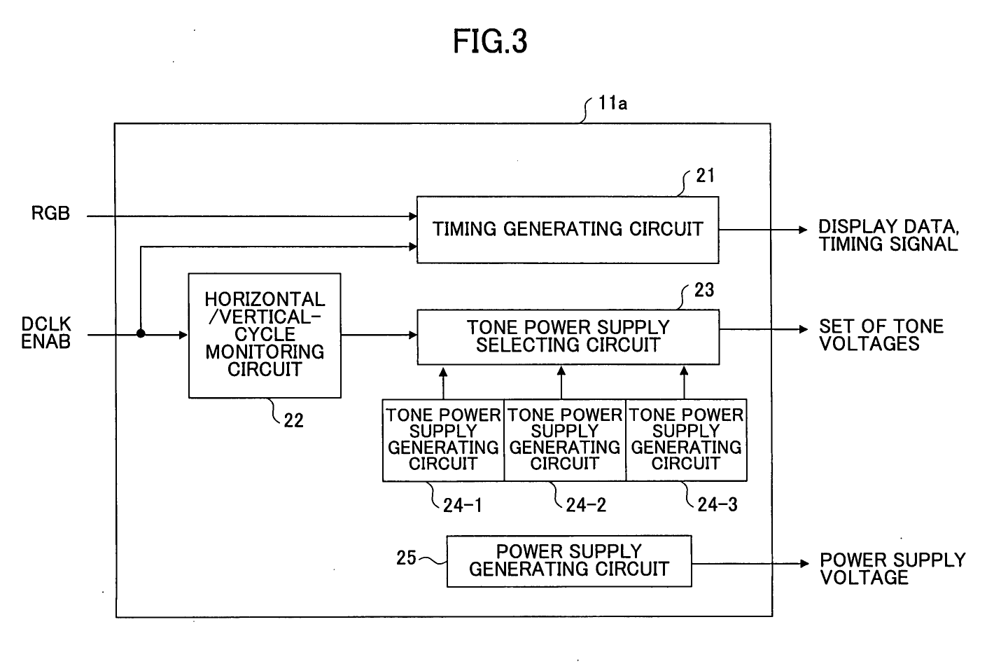

FIG. 3 is a drawing showing the configuration of the timing-controller-&-power-supply circuit 11a. The timing-controller-&-power-supply circuit 11a includes a timing generating circuit 21, a horizontal/vertical-cycle monitoring circuit 22, a tone power supply selecting circuit 23, tone power supply generating circuits 24-1 through 24-3, and a power supply generating circuit 25.

The timing generating circuit 21 receives the clock signal DCLK, the display data RGB, and the display enable signal ENAB indicative of the timing of display position so as to generate the various timing signals as previously described. Among the generated timing signals, the gate clock signal and start pulse signal are supplied to the gate driver 12 The dot clock signal, the data start signal, the latch pulse, and the polarity signal are supplied together with the display data to the data driver 13.

The horizontal/vertical-cycle monitoring circuit 22 receives the clock signal DCLK and the display enable signal ENAB, and detects a selected refresh rate based on these signals. The horizontal/vertical-cycle monitoring circuit 22 supplies to the tone power supply selecting circuit 23 a detection signal indicative of the selected refresh rate that is detected.

The tone power supply selecting circuit 23 receives the detection signal supplied from the horizontal/vertical-cycle monitoring circuit 22 and respective sets of tone voltages (three sets of tone voltages in this example) supplied from the tone power supply generating circuits 24-1 through 24-3. The tone power supply selecting circuit 23 selects a set of tone voltages corresponding to the selected refresh rate indicated by the detection signal, and supplies the selected set of tone voltages to the data driver 13.

The power supply generating circuit 25 generates power supply voltages for driving the LCD panel 10, the gate driver 12, and the data driver 13. The generated power supply voltages are supplied to the LCD panel 10, the gate driver 12, and the data driver 13.

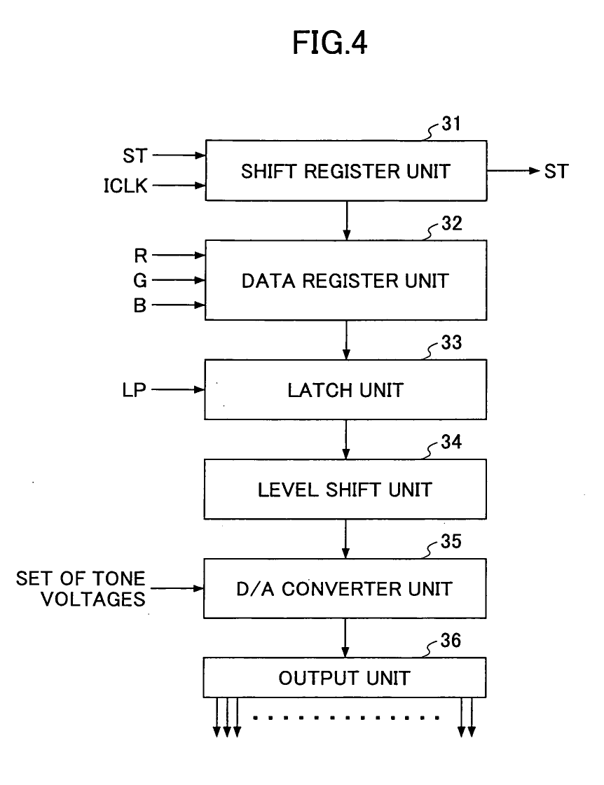

FIG. 4 is a drawing showing an example of the configuration of the data driver 13. The data driver 13 shown in FIG. 4 includes a shift register unit 31, a data register unit 32, a latch unit 33, a level shift unit 34, a D/A converter unit 35, and an output unit 36.

The shift register unit 31 successively asserts the output lines connected to the data register unit 32 one after another in synchronization with a dot clock signal ICLK supplied from the timing generating circuit 21. The timing at which the successive one-by-one assertion of the output lines is started is specified by a data start signal ST. To be specific, the flip-flops constituting the shift register of the shift register unit 31 successively latch and output the data start signal ST, resulting in the output lines connected to the data register unit 32 being successively asserted one after another. If the data driver 13 is comprised of a plurality of data drivers connected in a cascade series, the data start signal ST output from the last-stage flip-flop is supplied to a next stage data driver.

The data register unit 32 responds to the successive one-by-one assertion of the output lines extending from the shift register unit 31 by storing the RGB display data in internal register circuits as the data is supplied sequentially. In this manner, the data register unit 32 stores the corresponding portion of the display data on one display line (gate bus line). The display data stored in the data register unit 32 is latched by the latch unit 33 in synchronization with a latch pulse LP.

The digital display data stored in the latch unit 33 are then supplied to the D/A converter unit 35 via the level shift unit 34 for matching voltage ranges. The D/A converter unit 35 is provided with a DA converter circuit separately for each data bus line, and the DA converter circuits converts from digital to analog the input display data so as to output analog tone signals.

To be specific, the D/A converter unit 35 receives from the tone power supply selecting circuit 23 shown in FIG. 3 the set of tone voltages selected by the tone power supply selecting circuit 23. This set of tone voltages may be comprised of a plurality of voltages equal in number to the number of displayable tones. In this case, each voltage corresponds to one tone. Each DA converter circuit selects a voltage corresponding to the tone indicated by the digital display data from the set of tone voltages, and outputs the selected voltage as an analog tone signal. The set of tone voltages supplied from the tone power supply selecting circuit 23 may be comprised of a plurality of voltages (reference voltages) smaller in number than the number of displayable tones. In this case, each DA converter circuit generates a set of tone voltages corresponding to all the tones by dividing potentials between the voltages of the set of reference voltages, and then selects a voltage corresponding to the tone indicated by the digital display data from the set of tone voltages, followed by outputting the selected voltage as an analog tone signal.

The output unit 36 includes output buffers each provided separately for a corresponding one of the data bus lines, and each output buffer receives a corresponding analog tone signal from the D/A converter unit 35. Each output buffer provides the received analog tone signal to the TFT substrate as a data-bus-line drive signal for driving a data bus line.

In the present invention, the set of tone voltages used by the data driver 13 to drive the data bus lines is selected in response to the selected refresh rate. Accordingly, any set of tone voltages corresponding to any given refresh rate is arranged such as to achieve an optimum gamma value, so that the optimum gamma value can be maintained even when the refresh rate is changed.

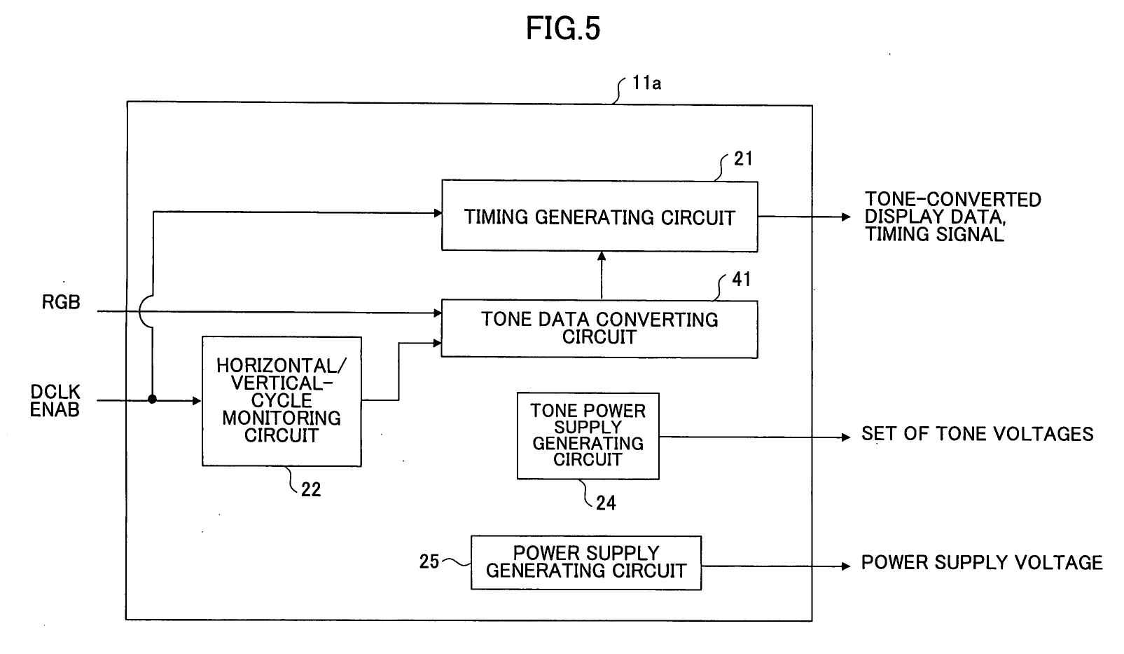

FIG. 5 is a drawing showing another example of the configuration of the timing-controller-&-power-supply circuit 11a. In FIG. 5, the same elements as those of FIG. 3 are referred to by the same numerals, and a description thereof will be omitted.

The timing-controller-&-power-supply circuit 11a of FIG. 5 includes the timing generating circuit 21, the horizontal/vertical-cycle monitoring circuit 22, a tone power supply generating circuit 24, the power supply generating circuit 41, and a tone data converting circuit 41.

The horizontal/vertical-cycle monitoring circuit 22 supplies to the tone data converting circuit 41 a detection signal indicative of the selected refresh rate that is detected. The tone data converting circuit 41 receives the detection signal supplied from the horizontal/vertical-cycle monitoring circuit 22 and the display data RGB supplied from the host apparatus. The tone data converting circuit 41 converts the tones of the display data RGB based on the tone conversion characteristics corresponding to the selected refresh rate indicated by the detection signal, and supplies the tone-converted display data to the timing generating circuit 21.

Specifically, a plurality of tone converting circuits having tone conversion characteristics corresponding to respective refresh rates may be provided, and one of the tone converting circuits corresponding to the selected refresh rate indicated by the detection signal may be selected, so that the selected tone converting circuit converts the tones of the display data RGB. Further, provision may be made such that no conversion is performed (i.e., by using a converting circuit producing outputs identical to its inputs) when the selected refresh rate is a standard refresh rate.

The timing generating circuit 21 receives the clock signal DCLK, the tone-converted display data, and the display enable signal ENAB indicative of the timing of display position so as to generate the various timing signals as previously described. Among the generated timing signals, the gate clock signal and start pulse signal are supplied to the gate driver 12 The dot clock signal, the data start signal, the latch pulse, and the polarity signal are supplied together with the tone-converted display data to the data driver 13.

The tone power supply generating circuit 24 generates a set of tone voltages for provision to the data driver 13. Namely, in the configuration shown in FIG. 5, the set of tone voltages supplied to the data driver 13 is fixed irrespective of the refresh rate.

When the configuration shown in FIG. 5 is used according to the present invention, the display data serving as a basis for the data driver 13 to drive the data bus lines is the display data that is converted based on the tone conversion characteristics selected in response to the selected refresh rate. Accordingly, any tone conversion characteristics corresponding to any given refresh rate may be arranged such as to achieve an optimum gamma value, so that the optimum gamma value can be maintained even when the refresh rate is changed.

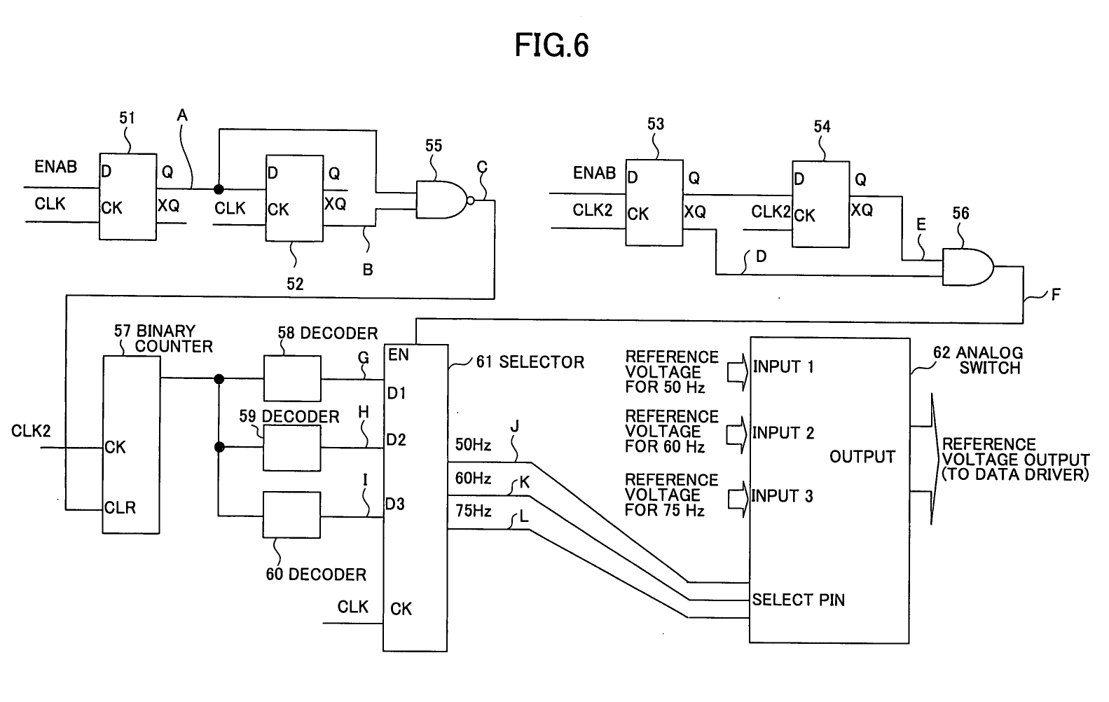

FIG. 6 is a drawing showing an example of the circuit configuration of the horizontal/vertical-cycle monitoring circuit 22. The horizontal/vertical-cycle monitoring circuit 22 of FIG. 6 includes flip-flops 51 through 54, a NAND gate 55, an AND gate 56, a binary counter 57, decoders 58 through 60, a selector 61, and an analog switch 62.

The circuit portion comprised of the flip-flops 51 and 52 and the NAND gate 55 shown in FIG. 6 generates a pulse signal based on the display enable signal ENAB and a clock signal CLK (e.g., the dot clock signal DCLK), such that the pulse signal becomes LOW at the timing one clock after the start of each horizontal cycle. This LOW pulse is supplied to the binary counter 57.

The binary counter 57 counts the number of pulses of a clock signal CLK2 (i.e., a reference-purpose clock signal generated independently of the dot clock signal DCLK) used to measure the refresh rate, i.e., counts up in response to each pulse of the clock signal CLK2. The LOW pulse described above resets the binary counter 57, thereby making it possible to count the number of pulses of the clock signal CLK2 included in each horizontal cycle.

The decoders 58 through 60 decode the count described above, and change their respective outputs to HIGH in response to the count exceeding respective predetermined values. These predetermined values are different for the different decoders 58 through 60. Accordingly, the length of the horizontal cycle can be determined roughly based on the outputs of the decoders 58 through 60. The outputs of the decoders 58 through 60 are supplied to the selector 61.

The circuit portion comprised of the flip-flops 53 and 54 and the AND gate 56 generates a pulse signal based on the display enable signal ENAB and the clock signal CLK2, such that the pulse signal becomes HIGH at the end of each horizontal cycle in synchronization with the clock signal CLK2. This HIGH pulse signal is supplied to an enable pin EN of the selector 61.

Based on the outputs of the decoders 58 through 60, the selector 61 sets one of the signals indicating 50 Hz, 60 Hz, and 75 Hz to HIGH. Based on the signals indicative of one of 50 Hz, 60 Hz, and 75 Hz supplied from the selector 61, the analog switch 62 selects a set of reference voltages (or set of tone voltages) for 50 Hz, a set of reference voltages (or set of tone voltages) for 60 Hz, or a set of reference voltages (or set of tone voltages) for 75 Hz, and outputs the selected set of voltages. The set of voltages output in this manner is supplied to the data driver 13.

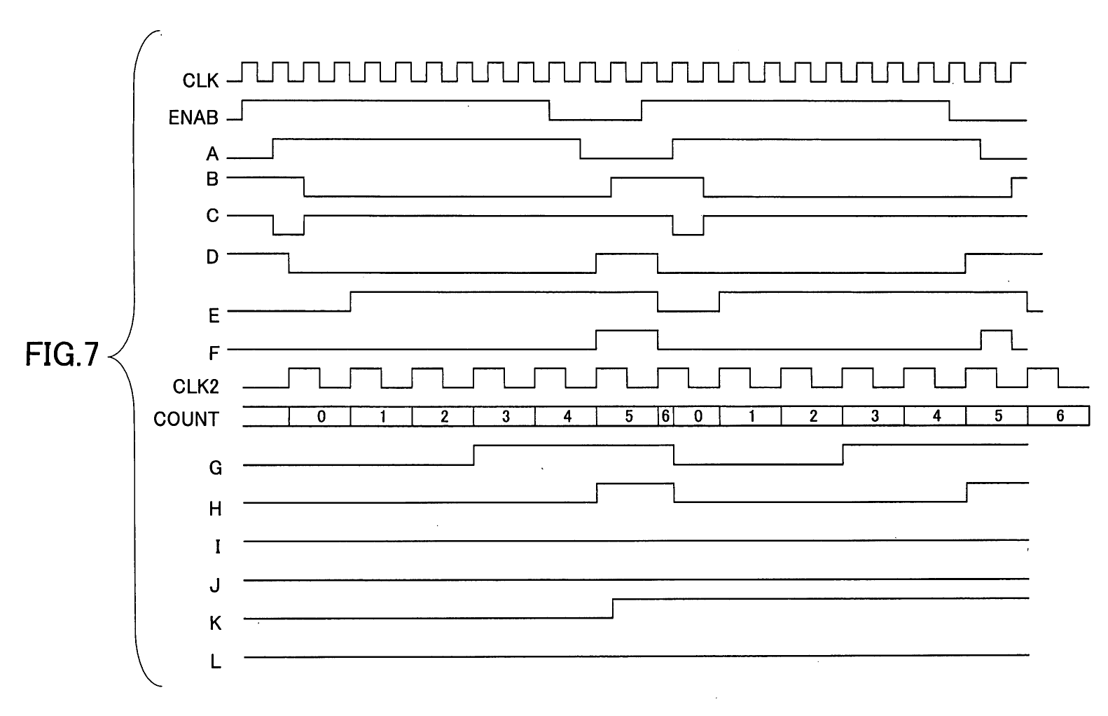

FIG. 7 is a timing chart showing the operation of the circuit of FIG. 6. The operation of the circuit of FIG. 6 will be described with reference to FIG. 7.

The individual signals shown in FIG. 7 are illustrated in the circuit diagram of FIG. 6 to indicate their positions. A signal A is the non-inverted output of the flip-flop 51, a signal B the inverted output of the flip-flop 52, a signal C the output of the NAND gate 55, a signal D the inverted output of the flip-flop 53, a signal E the non-inverted output of the flip-flop 54, a signal F the output of the AND gate 56, signals G through I the outputs of the respective decoders 58 through 60, and signals J through L the outputs of the selector 61.

The display enable signal ENAB serves to indicate a valid period of display data by becoming HIGH during the valid period of the display data in each horizontal cycle. The display enable signal ENAB is delayed by one clock of the clock signal CLK by the flip-flop 51 to generate the signal A. This signal A is further delayed by one clock of the clock signal CLK and inverted by the flip-flop 52 to generate the signal B. The NAND gate 55 performs a NAND operation between the signal A and the signal B, thereby producing the signal C, which becomes LOW at the start of each horizontal cycle (with a delay equal to one clock cycle of the clock signal CLK, to be exact).

The LOW pulse of the signal C resets the binary counter 57. The count value of the binary counter 57 (shown as “COUNT” in FIG. 7) thus starts its count-up operation from an initial value of 0 to match the start of each horizontal cycle. As previously described, the count-up operation of the binary counter 57 is synchronized with the clock signal CLK2.

The decoder 58 changes its output signal G to HIGH when the count value becomes equal to or larger than 3, for example. The decoder 59 changes its output signal H to HIGH when the count value becomes equal to or larger than 5, for example. The decoder 59 changes its output signal I to HIGH when the count value becomes equal to or larger than 7, for example. The final value of the count is proportional to the length of the horizontal cycle. The decoders 58 through 60 may be appropriately arranged in accordance with the cycle of the clock signal CLK2, such that only the signal G becomes HIGH in the case of the refresh rate being 75 Hz, such that the signals G and H become HIGH in the case of the refresh rate being 60 Hz, and such that all the signals G, H, and I become HIGH in the case of the refresh rate being 50 Hz, for example.

The display enable signal ENAB is synchronized to the clock signal CLK and inverted by the flip-flop 53 to generate the signal D. The non-inverted output of the flip-flop 53 (i.e., the inversion of the signal D) is delayed by one clock of the clock signal CLK2 by the flip-flop 54 to generate the signal E. The AND gate 56 performs an AND operation between the signal D and the signal E, thereby producing the signal F, which becomes HIGH at the end of each horizontal cycle in synchronization with the clock signal CLK2.

The HIGH level of the pulse signal F places the selector 61 in an enabled state. Namely, the selector 61 sets one of the signal J indicating 50 Hz, the signal K indicating 60 Hz, and the signal L indicating 75 Hz to HIGH in response to the states of the signals G, H, and I at the timing at which the pulse signal F is HIGH.

The horizontal/vertical-cycle monitoring circuit 22 shown in FIG. 6 is configured to detect the refresh rate based on the measurement of the horizontal cycle as described in connection with FIG. 7. This is not a limiting example, and the horizontal/vertical-cycle monitoring circuit 22 may be configured to detect the refresh rate based on the measurement of the vertical cycle. As previously described, the portion of the display enable signal at which the LOW period continues for more than a predetermined number of clock pulses is detected to identify the start position of each frame, which may be utilized to measure the vertical cycle, for example.

Further, the present invention is not limited to these embodiments, but various variations and modifications may be made without departing from the scope of the present invention.

The present application is based on Japanese priority application No. 2005-152899 filed on May 25, 2005, with the Japanese Patent Office, the entire contents of which are hereby incorporated by reference.

What is claimed is:

1. A liquid crystal display apparatus, comprising:
a liquid crystal panel;
a data driver configured to drive the liquid crystal panel; and
a control circuit configured to control the data driver in response to display data and a control signal supplied from an exterior,
wherein the control circuit is configured to change a relationship between tones of the display data and voltages used by the data driver to drive the liquid crystal panel, such that the relationship is responsive to one of a horizontal cycle and a vertical cycle specified by the control signal.

2. The liquid crystal display apparatus as claimed in claim 1, wherein the control circuit includes a plurality of voltage generating circuits, and is configured to select one of the voltage generating circuits in response to one of the horizontal cycle and the vertical cycle specified by the control signal, such that voltages generated by the selected voltage generating circuit are supplied to the data driver.

3. The liquid crystal display apparatus as claimed in claim 2, wherein the data driver includes a D/A converting circuit for generating an analog voltage through D/A conversion of the display data, and the D/A converting circuit is configured to generate the analog voltage based on the voltages generated by the selected voltage generating circuit.

4. The liquid crystal display apparatus as claimed in claim 1, wherein the control circuit includes a tone data converting circuit for performing a tone conversion by converting tones of the display data, and the tone data converting circuit is configured to change conversion characteristics of the tone conversion in response to one of the horizontal cycle and the vertical cycle specified by the control signal.

5. The liquid crystal display apparatus as claimed in claim 4, wherein the control circuit is configured to control the data driver in response to the tone-converted display data and the control signal.

6. A control circuit, configured to be connectable to a unit that includes a liquid crystal panel and a data driver for driving the liquid crystal panel, configured to control the data driver based on display data and a control signal supplied from an exterior, and configured to change a relationship between tones of the display data and voltages used by the data driver to drive the liquid crystal panel, such that the relationship is responsive to one of a horizontal cycle and a vertical cycle specified by the control signal.

7. The control circuit as claimed in claim 6, comprising a plurality of voltage generating circuits, and configured to select one of the voltage generating circuits in response to one of the horizontal cycle and the vertical cycle specified by the control signal, such that voltages generated by the selected voltage generating circuit are supplied to the data driver.

8. The control circuit as claimed in claim 6, comprising a tone data converting circuit for performing a tone conversion by converting tones of the display data, wherein the tone data converting circuit is configured to change conversion characteristics of the tone conversion in response to one of the horizontal cycle and the vertical cycle specified by the control signal.

9. A method of driving a liquid crystal display panel, comprising:
receiving a display data signal and control signal;
controlling a data driver for driving a liquid crystal panel based on the display data signal and the control signal;
detecting one of a horizontal cycle and a vertical cycle specified by the control signal; and
changing a relationship between tones of the display data and voltages used by the data driver to drive the liquid crystal panel, such that the relationship is responsive to the detected cycle.

10. The method as claimed in claim 9, wherein the step of changing the relationship includes a step of selecting one of a plurality of relationships in response to the detected cycle wherein the relationships between tones of the display data and voltages used by the data driver to drive the liquid crystal panel are prepared in advance.
